(19) United States
(12) Patent Application Publication
(10) Pub. No.: US 2008/0087482 A1
(43) Pub. Date: Apr. 17, 2008

(54) HYBRID ELECTRIC VEHICLE WITH MOTOR DRIVEN CHARGE AIR BOOSTER

(75) Inventors: David Ledger, Dearborn, MI (US); Floyd Cadwell, Dearborn, MI (US); George Dolan, Commerce Twp., MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/549,354

(22) Filed: Oct. 13, 2006

(51) Int. Cl. B60K 6/00

(52) U.S. Cl. 180/165

(57) ABSTRACT

A hybrid electric vehicle includes an internal combustion engine and a traction battery. A rotating electrical machine coupled to said engine charges the traction battery. A motor driven charge air booster operatively connected with said traction battery and with said air inlet functions as an electrically driven supercharger.

### BACKGROUND OF THE INVENTION

1. Field of the Invention

The present invention relates to a hybrid electric vehicle having an internal combustion engine which is selectively supplied with charge air at superatmospheric pressure by an electric motor driven air compressor connected with the vehicle's traction battery.

2. Disclosure Information

Hybrid electric vehicles utilize not only an internal combustion engine, but also a traction motor for the purpose of driving the vehicle. A principal objective of hybrid electric vehicles is the minimization of fuel consumption. In this type of vehicle, fuel economy is promoted by minimizing the installed system weight of the vehicle's powertrain. Of course, the prime mover, an internal combustion engine, contributes a high proportion of the powertrain installed weight. Thus, it is desirable to minimize the weight of the internal combustion engine. Unfortunately, minimization of weight of an engine usually comes at the expense of reduced power and, if taken to an extreme, the performance of a vehicle may suffer greatly as a result of such reduced power.

It is known in the automotive world to use power adders such as turbochargers and other sorts of air compressing devices. Turbochargers, while providing increased performance, require special plumbing for cooling and lubrication systems. Turbocharger operation may be marked by an annoying lag in achieving the desired charge boosting during transient operation. Although electric motor driven superchargers are known, such devices have typically been unsatisfactory because they are installed without adequate controls, and in vehicles having smaller electrical systems which cannot provide enough electrical power to quickly accelerate the supercharger, so as to avoid the previously described time lag phenomenon. Additionally, performance of known motor driven supercharging devices generally degrades after repeated vehicle accelerations due to the use of undersized electrical power sources.

### SUMMARY OF THE INVENTION

The present system provides a hybrid electric vehicle with a motor driven charge air booster having an adequate range of authority to provide significant power improvement for an engine, without a significant weight penalty, and without the drawbacks associated with prior art turbochargers and other charge boosting devices.

According to a first aspect of the present invention, a hybrid electric vehicle includes an internal combustion engine having an air inlet. A rotating electrical machine, such as an alternator, is coupled to the engine. As used herein, the term “generator” means either a generator, or an alternator, or any other type of rotating electrical machine which converts shaft horsepower to an electric current.

A traction battery is connected with the rotating electrical machine. A motor driven charge air booster is operatively connected with the traction battery and with the air inlet, such that when the motor is energized, the charge air entering the engine will be elevated to a pressure above the ambient pressure. The rotating electrical machine is preferably driven through a gearset. In a preferred embodiment, the gearset is a planetary gearset.

According to another aspect of the present invention, a powertrain includes an air bypass valve for selectively connecting the charge air booster with the air inlet.

According to another aspect of the present invention, a vehicle includes at least one traction motor operatively connected with the traction battery. A controller operates the charge air booster as a function of at least one vehicle operating parameter, which may include such parameters as state of charge of the traction battery, time rate of change of accelerator position, the magnitude of the load imposed upon the internal combustion engine, the torque output of the traction motor, and other operating parameters known to those skilled in the art and suggested by this disclosure.

According to another aspect of the present invention, a charge air booster includes a variable speed motor coupled to an air compressor, such as a centrifugal air compressor.

It is an advantage of the present hybrid electric vehicle that superior performance may be achieved with a smaller installed system weight by using a smaller displacement engine, coupled with the present eminently controllable charge boosting device.

It is a further advantage of a system according to the present invention that charge air may be provided with minimal heat gain in the compression process, so as to minimize the need for intercooling. This advantages arises from the fact that it is not necessary to expose any part of the charge boosting device to the engine's hot exhaust gases.

It is yet another advantage of a system according to the present invention that a motor driven charge air booster is coupled to a high voltage, high current source, preferably a traction battery, so as to allow boost to be generated in a very short time period, as opposed to the response periods associated with turbocharger devices.

Other advantages, as well as features and objects of the present invention, will become apparent to the reader of this specification.

### BRIEF DESCRIPTION OF THE DRAWINGS

FIG. 1 is a schematic representation of a hybrid electric vehicle according to the present invention.

### DETAILED DESCRIPTION OF THE PREFERRED EMBODIMENTS

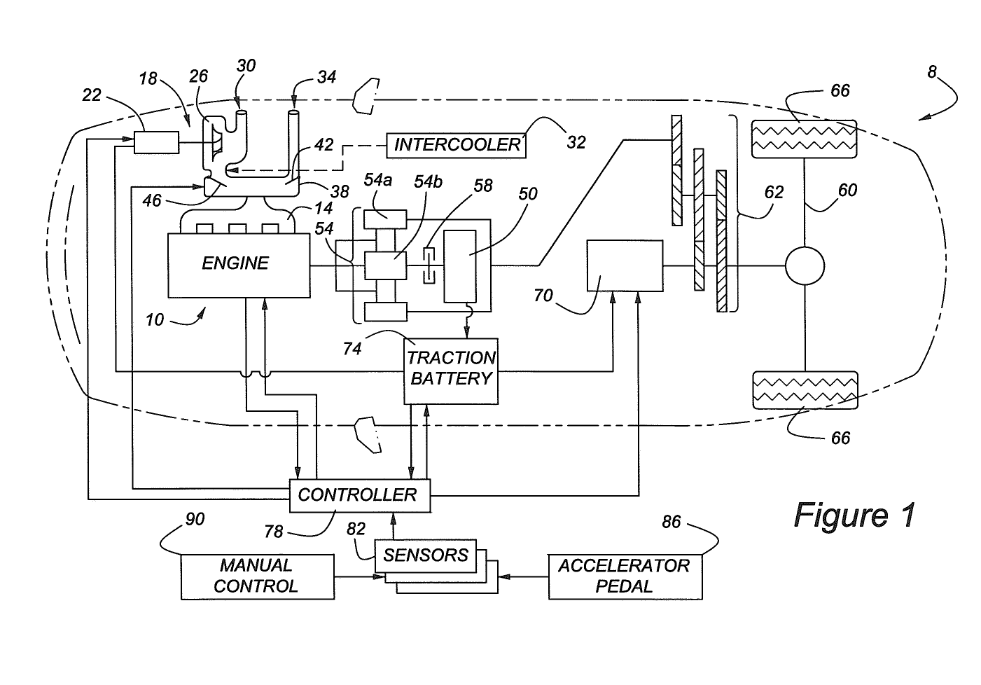

As shown in FIG. 1, vehicle 8 has engine 10 with an air inlet, 14, which is furnished with air through either naturally aspirated air inlet 34 or compressed air inlet 30. Air entering through inlet 30 passes through centrifugal compressor 26, where it is compressed and sent to air box 38. Those skilled in the art will appreciate in view of this disclosure that other types of rotating compressors, such as screw compressors or multi-lobed positive displacement machines could be employed with the present inventive system.

Centrifugal compressor 26 is powered by variable speed motor 22. Motor 22 is operated by controller 78 and powered by traction battery 74. Traction battery 74 is preferably a high voltage, high current traction battery having operating voltage in the range of 12 to 1000 volts, depending upon the weight of vehicle 8 and the desired engine performance.

Air box 38 includes a naturally aspirated airflow control valve, 42, and a compressed air control valve, 46, with purpose of the control valves to allow air to flow into engine 10 through either compressed air inlet 30 or naturally aspirated air inlet 34. Optionally, intercooler 32 may be interposed between the outlet of compressor 26 and control valve 46.

Engine 10 is connected with a generator, 50, through a planetary gearset, 54. Ring gear 54a of planetary gearset 54 is connected by a gear train, 62, to axle 60, upon which road wheels 66 are mounted. A brake, 58, is positioned between planetary gearset 54 and generator 50, and allows either the generator or gear train 62 to be driven selectively by engine 10. Brake 58 is optional equipment which may be specified according to the needs of any particular vehicle to which the present invention is being applied.

The output of generator 50 is directed to traction battery 74, which is operably connected with traction motor 70, which too, is operated by controller 78. Thus it may be seen that engine 10 may either drive vehicle 8 alone, or traction motor 70 may be used alone to drive vehicle, or a combination of engine 10 and traction motor 70 may be used to power the vehicle.

Controller 78 operates charge air booster 18 as a function of several vehicle operating parameters. In general, it is desired to obtain higher output from engine 10 in response to driver commands such as the time rate of change of position of accelerator pedal 86. Of course, the output of charge air booster 18 is dependent upon the supplied voltage and current available from traction battery 74, as well. Moreover, engine load and speed are important parameters in the calculation of the desired boost from charge air booster 18. A number of operating parameter sensors, 82, are provided. These sensors include a position sensor for accelerator pedal 86, as well as sensors for the state of charge of traction battery 74, various operating temperatures, vehicle speed, engine speed, and yet other parameters known to those skilled in the art and suggested by this disclosure.

Controller 78 operates variable speed motor 22 so as to achieve a desired boost in response to the values of chosen operating parameters. For example, if the time rate of change of the position of accelerator pedal 86 is used as a parameter, a quick depression of the accelerator pedal may be read as an indication that the vehicle's driver has desired maximum or near-maximum acceleration performance, and charge air booster 18 will be energized and operated at a substantial rotational speed. If, however, the time rate of change of the position of accelerator pedal 86 is low, it is a sign that the driver is not attempting to achieve high rates of vehicle acceleration and charge air booster 18 may be operated at a concomitantly lower rotation rate.

As noted above, the battery of sensors 82 tracks various vehicle parameters such as vehicle speed, temperatures such as ambient temperature and engine operating temperature, ambient pressure, battery temperature, battery state of charge, transmission gear position, and other operating parameters known to those skilled in the art and suggested by this disclosure. Such parameters are useful for determining appropriate regimes for powering charge air booster 18. For example, if traction battery 74 is discharged, or if the temperature of engine 10 is too great, charge air booster 18 will not be operated. Manual control 90 is yet another device monitored by sensors 82. Control 90 may be embodied as a driver-selectable switch mounted in the location of other driver-accessible controls. Control 90 could be activated by the motorist so as to power up charge air booster 18 whenever engine 10 is delivering power at speeds above idle.

While particular embodiments of the invention have been shown and described, numerous variations and alternate embodiments will occur to those skilled in the art. Accordingly, it is intended that the invention be limited only in terms of the appended claims.

What is claimed is:

1. A hybrid electric vehicle, comprising:
an internal combustion engine having an air inlet;
a rotating electrical machine coupled to said engine;
a traction battery connected with said rotating electrical machine; and
a motor driven charge air booster operatively connected with said traction battery and with said air inlet.

2. A hybrid electric vehicle according to claim 1, wherein said rotating electrical machine comprises a generator driven through a gearset.

3. A hybrid electric vehicle according to claim 1, wherein said rotating electrical machine comprises a generator driven through a planetary gearset.

4. A hybrid electric vehicle according to claim 1, further comprising an air bypass valve for selectively connecting said charge air booster with said air inlet.

5. A hybrid electric vehicle according to claim 1, further comprising at least one traction motor operatively connected with said traction battery.

6. A hybrid electric vehicle according to claim 1, further comprising a controller for operating said charge air booster as a function of at least one vehicle operating parameter.

7. A hybrid electric vehicle according to claim 6, wherein said controller controls said charge air booster as a function of at least the state of charge of said traction battery.

8. A hybrid electric vehicle according to claim 6, wherein said controller controls said charge air booster as a function of at least the time rate of change of the position of an accelerator pedal installed in said vehicle.

9. A hybrid electric vehicle according to claim 6, wherein said controller controls said charge air booster as a function of at least the load imposed upon said internal combustion engine.

10. A hybrid electric vehicle according to claim 1, further comprising a traction motor connected with said traction battery.

11. A hybrid electric vehicle according to claim 10, wherein said controller controls said charge air booster as a function of at least the torque output of said traction motor.

12. A hybrid electric vehicle according to claim 1, wherein said motor driven charge air booster comprises a variable speed motor coupled to an air compressor.

13. A hybrid electric vehicle according to claim 12, wherein said air compressor comprises a centrifugal air compressor.

14. A hybrid electric vehicle according to claim 1, further comprising a charge air intercooler positioned between said charge air booster and said air inlet.

15. A hybrid electric vehicle, comprising:
an internal combustion engine having an air inlet;
an electrical generator coupled to said engine;
a traction battery connected with said electrical generator;
a traction motor operatively connected with said traction battery;
a motor driven charge air booster operatively connected with said traction battery and with said air inlet; and
a controller operatively connected with said traction battery, and with said charge air booster, with said controller operating said charge air booster as a function of a plurality of operating parameters including at least the state of charge of said traction battery.

16. A hybrid electric vehicle according to claim 15, wherein said controller operates said charge air booster as a function of at least the state of charge of said traction battery and the value of at least one operating parameter associated with the driver of said vehicle.

17. A hybrid electric vehicle according to claim 16, wherein said at least one operating parameter associated with the driver of said vehicle comprises the time rate of change of position of an accelerator pedal installed in said vehicle.

18. A hybrid electric vehicle according to claim 16, wherein said at least one operating parameter associated with the driver of said vehicle comprises a driver-selectable control for powering said charge air booster.
